(19) United States
(12) Patent Application Publication
(10) Pub. No.: US 2002/0045003 A1
(43) Pub. Date: Apr. 18, 2002

(54) Manufacturing method of nutritive bean curd

(76) Inventor: Kyong Shik Kim, Brooklin, NY (US)

Correspondence Address: I P STRATEGIES, 806 7TH STREET, N.W., SUITE 301, WASHINGTON, DC, 20001, US

(21) Appl. No.: 09/756,211

(22) Filed: Jan. 9, 2001

(30) Foreign Application Priority Data
Oct. 18, 2000 (KR) 2000/61234

(51) Int. Cl. A23L 1/20

(52) U.S. Cl. 426/634

(57) ABSTRACT

The present invention relates to manufacturing method of nutritive bean curd adding vegetable food. particularly the present invention relates to manufacturing method of nutritive bean curd by mixing a bean flour and vegetable additives that is made by washing and pulverizing a kind of good vegetables among a spinach, a leek, a pumpkin, a ginger, an onion, a garlic a green onion, a crown daisy, a carrot, a sesame leaf a wormwood, a pine needles, a green tea, a mulberry leaves and ginseng.

Thus the bean curd contains all sorts of nutrition and effective ingredients of the said vegetable food, eliminates a somewhat fishy smell of bean's flavor, and applies this tasty bean curd in cooking various food.

### FIELD OF INVENTION

The present invention relates to manufacturing method of nutritive bean curd by mixing a bean flour and vegetable additives containing an allyl sulfide, flavonoid, saponin, hydrated acid and many other ingredients which have good and fragrant tastes and have lots of vitamins and minerals, thus the bean curd contains all sorts of nutrition effective ingredients of said vegetable food and eliminates a somewhat fishy smell of beans flavor and applies this tasty bean curd in cooking various food

### BACKGROUND OF THE INVENTION

The conventional method of manufacturing a bean curd which is the korean traditional foodstuff and the good provider of protein is to wash a bean and soak the bean in a water for 24 hours, to mix with the water which is 2 times more than the bean in the amount to pulverize the bean to be a bean flour. This bean flour is heated at a temperature of 100° C. for 30-40 minutes to make a processed article which in turn is filtered to divide into bean juice and refuse. Then a coagulating agent in the amount of 0.01 wt % of a bean juice is added to the bean juice which is heated at a temperature of 80-90° C. to make a uncurdled bean curd, which is again condensed in a machine. The bean curd is manufactured by hydrating and moulding the condensed uncurdled bean curd.

### SUMMARY OF THE INVENTION

The conventional bean curd is made of bean only resulting to the effect that the taste is not so good due to the somewhat fishy smell of bean's peculiar flavor that it is applied in cooking limited foods and that the color of it is tinged with dark milk white so that the overall market value of the traditional bean curd in comparatively lowered.

The present invention relates to manufacturing method of nutritive bean curd by mixing a bean flour and vegetable additives containing an allyl sulfide, flavonoid, saponin and hydrated acid and many other ingredients which have good and fragrant tastes and have a lot of vitamins and minerals. The present bean curd contains all sorts of nutrition and effective ingredients of said vegetable food and eliminates a somewhat fishy smell of bean's peculiar flavor and applies this tasty bean curd in cooking various food.

A spinach contains balanced percentage of carotene, vitamin B1, B2, C, protein, hydrochloric acid, calcium, iodine and specially, there is much of iron. It also contains hydrated acid which shows puckery taste removing the somewhat fishy taste of the bean. A leek contains a high percentage of vitamin A, B1, C and calcium. Specially vitamin A can be found in abundance in a leek. The allyl sulfide in a leek present peculiar flavor and it accelerates secretion of digestion enzymes, activates a internal organs of human body, improves blood circulation, accelerates an absorption of vitamin B1 and eliminates a somewhat fishy smell of bean to improve the taste of bean curd.

A main ingredient of a pumpkin is saccharide. A pumpkin contains lots of saccharide as a main ingredient, carotene, vitamin B1 vitamin B2 vitamin C, calcium and iron. The pumpkin gives sweet flavor in bean curd for it has peculiar sweet taste.

A hot taste of a ginger is from gingeron and ginger oil and fragrance of it is from cinna oil, gingiberen, gingirol. In herb clinic, the ginger is regarded to be a very outstanding in intestinal orders, diaphoresis and stomach tonic. The hot taste and fragrance of the ginger improves the taste of bean curd by eliminating completely somewhat fishy smell of a bean's peculiar flavor. An onion contains lots of saccharide and allyl sulfide. When the onion is heated the saccharoid and allyl sulfide interact each other to bring a result of a sweat flavor of the onion. Also the allyl sulfide accelerates the absorption of vitamin B1 and removes the somewhat fishy flavor. The onion purifies a human blood and protects the human heart.

A garlic contains a lot of vitamins B1. Allyl sulfide, a source of bad smell of garlic combines with allysine to produce a allylthiamine which improves the efficacy of vitamin B1. Also, allyl sulfide has a strong germicidal power. Hot and fragrant taste of garlic works as an agent to eliminate a somewhat fishy smell of beans peculiar flavor. The garlic improves the digestive function, purifies human blood. In a herb medicine, the garlic is applied to a stomach tonic, diaphoresis, urination, expectorant, intestinal order, diarrhea remedy, counter poison and vermicide.

A green onion contains high percentage of carotene, vitamin B1 and vitamin B2. Allyl sulfide, the source of peculiar flavor of green onion, is an outstanding agent of digestion and antibiotics. The green onion is outstanding in maintaining a warmth in a body and is also outstanding in the function of urination and vermicide. Ingredients of a crown daisy are carotene, vitamin A, vitamin B2, vitamin C, calcium, iron and lysine. The crown daisy keeps the warmth of stomach and strengthens the function of intestines and improves the taste of bean curd eliminating the somewhat fishy smell of beans peculiar flavor. A carrot is full of carotene and improves the taste of bean curd eliminating the somewhat fishy smell of beans peculiar flavor. A sesame leaf is a good source of protein saccharide, vitamin A, vitamin B1, B2 and C. The flavor of it is due to the perilla aldehyde, the function of which is to prevent putrefaction. The sesame leaf eliminates the somewhat fishy smell of bean's peculiar flavor.

A wormwood has sufficient percentage of vitamin A, vitamin B1, vitamin B2, vitamin C, niacin, calcium, phosphorus and iron which have various medical function; an antifebric, an alleviation of pain, an antiphlogistic, counter poison, vermicide, hypotensive drug, the abatement of temperature. Special flavor of wormwood removes the somewhat fishy smell of beans peculiar flavor and improves the taste of bean curd.

Pine leaf has good percentage of vitamin A, vitamin C, vitamin K, beta-carotene flavonoid and antocyane and helps an oxidation-deoxidation process, antiphlogistic process, homestatic and dropping a blood sugar of a living body. Chlorophyl is good for blood-making and injury healing. Unique fragrance of pine leaf comes from both flavonoid and oil of terebinth and removes the somewhat fishy smell of beans peculiar taste to improve at taste of bean curd.

A polyphenol the main ingredient of green tea, can be mixed with many substances easily resulting of removal of a heavy metal, deoxidation, debilitation of cancer-causing materials, antidote for poison.

A mulberry leaf contains, flavonoid, coumagine, chlorogensene, fumaric acid, folic acid, amino acid, thiamine, riboflavine, pyridoxine, nicotinic acid. Therefore, the ingredients result dropping of blood sugar, enlargement of blood vessel, curing a high blood pressure, diabetic symptoms. The fragrance of flavonoid eliminates the somewhat fishy smell of bean's peculiar taste to improve the taste of bean curd.

In ginseng there abound ingredients: monosaccharide, disaccharide, trisaccharide, saponin, amino acid, alkaloid, panaxinol, cytosterol, vitamin B group and choline. The ingredients are very outstanding in activation of the adrenal fortex function, stimulation of the cerebral cortex, dropping of the blood pressure, stimulation of breath, controlling of the blood saccaride, reinforcement of insulin function reinforcement of a red blood cell and hemoglobin, acceleration of alimentary canal movement, retrieving from fatigue, improving of workability and acceleration of sex gland growth. Slightly bitter taste of saponin and bitter taste of alkaloid improve the taste of bean curd eliminating somewhat fishy smell of bean's peculiar taste

### DETAILED DESCRIPTION OF THE PREFERRED EMBODIMENT

The nutritive bean curd is manufactured through the following process:

a process of washing a bean and soak the bean in water for 24 hours;

a process of making a bean floor pulverizing the soaked bean after mixing water which amount is 2 times the soaked bean;

a process of preparing a vegetable additives by washing and pulverizing a kind of vegetables chosen from spinach, leek, pumpkin, ginger, onion, garlic, green onion, crown daisy, carrot, sesame leaf, wormwood, pine leaf, green tea, mulberry leaves and ginseng;

a process of forming a processed materials heating the bean flour at a temperature of 100° C. which was added by the vegetable additives and water;

a process of separating a bean milk and bean curd refuge by filtering the processed goods produced by the heating process;

a process of heating the separated bean milk in a reaction vessel in a temperature of 80˜90° C. and coagulating the bean milk adding coagulation agent 0.02-0.04 wt % to make a nutritive uncurdled bean curd; and

a process of forming nutritive bean curd condensing and dehydrating the said nutritive uncurdled bean curd;

A vegetable food mixing with bean flour may be selected considering an ingredients of it and considering the kind of food being cooked. The vegetable foodstuff can be pulverized to easily come off the ingredients in a heating process before mixing with bean flours. Vegetable additive to the bean flour may be mulberry leaves or ginseng the ingredients of which soak out slowly. To speed up the soaking out, heating of vegetable additive at a temperature of 100° C. for 60˜70 minutes is made to produce a processed article which in turn coagulate to a uncurdled bean curd adding coagulating agent of 0.02 wt % of bean milk. Vegetable additive to the bean flour may be a pumpkin, a ginger, an onion, or a garlic the ingredients of which sock out comparatively slowly. To speed up the soaking out, heating of vegetable additive at a temperature of 100° C. for 20˜60 minutes is made to produce a processed article which in turn coagulate to a uncurdled bean curd adding coagulating agent of 0.03 wt % of bean milk. Vegetable additive to the bean flour may be a spinach, a leek, a crown daisy, a carrot, a sesame leaf or green tea the ingredients of which sock out rapidly and vitamins contained therein are easily destroyed. In the heating process at a temperature of 100° C. for 40 minutes, the vegetable additives is mixed with bean flour and heating is again made at a temperature of 100° C. for 1˜10 minutes to produce a processed article which in turn coagulate to a uncurdled bean curd adding coagulating agent of 0.04 wt % of bean milk. A little more agent is added in the process in making the uncurdled bean curd than in making the normal bean curd because of the hindrance of vitamin in additives of the coagulation function. Nutritive bean curd produced by the said method is tinged with the same color of the vegetable additives.

### EXAMPLE 1

Beans are cleanly washed to be without dusts and impurities. Then put them into a water tank to be soaked for 24 hours. Soaked beans are pulverized by millstone pulverizer with water 2 times of the bean in amount to form a bean flour. Ginseng are cleanly washed to be without dusts and impurities. Then the ginseng are pulverized by millstone pulverizer to help the ingredients of them well soaked. Then they become gingseng additives, 85-97 wt % of bean flour formed in the said pulverization process and 3-15 wt % of the ginseng additives in the said preparation process are mixed in a reaction vessel and heat them at a temperature of 100° C. for 70 minutes to make the ingredients of ginseng additives are sufficiently soaked and at last the processed goods come to be. The above said processed goods pass through a 200 mesh sieve to sift out bean curd refuge from bean milk. The said bean milk is heated at a temperature of 80-90° C. and add 0.02 wt % of coagulating agent to make a nutritive uncurdled bean curd. The nutritive uncurdled bean curd is put in a machine to compress and dehydrate to from a nutritive bean curd.

### EXAMPLE 2

Beans are cleanly washed to be without dusts and impurities. Then put them into a water tank to be soaked for 24 hours. Soaked beans are pulverized by millstone pulverizer with water 2 times of the bean in amount to form a bean flour. Ginseng are cleanly washed to be without dusts and impurities. Then the ginseng are pulverized by millstone pulverizer to help the ingredients of them well soaked. Then they become gingseng additives. Bean flour formed in the said pulverization process put in a reaction vessel and heat them at a temperature of 100° C. for 40 minutes to make the processed goods. The above said processed goods pass through a 200 mesh sieve to sift out bean curd refuge from bean milk. 85-97 wt % of bean milk and 3-15 wt % of the ginseng additives are mixed in a reaction vessel to form nutritive bean milk. The said bean milk is heated at a temperature of 80-90° C. and add 0.02 wt % of coagulating agent to make a nutritive uncurdled bean curd. The nutritive uncurdled bean curd is put in a machine to compress and dehydrate to form a nutritive bean curd.

### EXAMPLE 3

Example 1 applies to example 3 except for the process of preparing the mulberry leaves additives in which the mulberry leaves are washed, pulverized by millstone pulverizer, and 75-90 wt % of bean flour formed in the pulverizing process mixing with 10-25 wt % of mulberry leaves additives formed in the preparation process in the reaction vessel to heat at a temperature of 100° C. for 60 minutes to make the process article.

### EXAMPLE 4

Example 2 applies to example 4 except for the process of preparing the mulberry leaves additives in which the mulberry leaves are washed, pulverized by millstone pulverizer, and 80-95 wt % of bean milk separated in the separation process mixing with 5-20 wt % of mulberry leaves additives formed in the preparation process in the reaction vessel to make the nutritive bean milk.

### EXAMPLE 5

Beans are cleanly washed. Then put them into a water tank to be soaked for 24 hours. Soaked beans are pulverized by millstone pulverizer with water 2 times of the bean in amount to form a bean flour. Pumpkin are cleanly washed. Then the pumpkin are pulverized by millstone pulverizer to prepare the pumpkin additives. Bean flour formed in the said pulverization process put in a reaction vessel and heat them at a temperature of 100° C. for 30 minutes and mix with the pumpkin additives in the amount of 15-35 wt % of the bean flour and heat again at a temperature of 100° C. for 20 minutes to form a processed goods. The above said processed goods pass through a 200 mesh sieve to sift out bean curd refuge from bean milk. The said nutrutive bean milk is heated at a temperature of 80-90° C. in the reaction vessel and add 0.03 wt % of coagulating agent to make a nutritive uncurdled bean curd. The nutritive uncurdled bean curd is put in a machine to compress and dehydrate to form a nutritive bean curd.

### EXAMPLE 6

Beans are cleanly washed. Then put them into a water tank to be soaked for 24 hours. Soaked beans are pulverized by millstone pulverizer with water 2 times of the bean in amount to form a bean flour. Pumpkin are cleanly washed. Then the pumpkin are pulverized by millstone pulverizer to prepare the pumpkin additives. Bean flour formed in the said pulverization process put in a reaction vessel and heat them at a temperature of 100° C. for 40 minutes to make the processed goods. The above said processed goods pass through a 200 mesh sieve to sift out bean curd refuge from bean milk. 75-95 wt % of bean milk and 5-25 wt % of the pumpkin additives are mixed in a reaction vessel to form nutritive bean milk. The said bean milk is heated at a temperature of 80-90° C. and add 0.02 wt % of coagulating agent to make a nutritive uncurdled bean curd. The nutritive uncurdled bean curd is put in a machine to compress and dehydrate to form a nutritive bean curd.

### EXAMPLE 7

Example 5 applies to example 7 except for the process of preparing the ginger additives in which the ginger are washed, pulverized by millstone pulverizer; and after heating bean flour formed in the pulverization process at a temperature of 100° C. for 20 minutes in the reaction vessel, the said ginger additives are mixed in the amount of 3-10 wt % of the bean flour to be heated at a temperature of 100° C. for 25 minutes; the processed goods are formed.

### EXAMPLE 8

Example 6 applies to example 8 except for the process of preparing the ginger additives in which the gingers are washed, pulverized by millstone pulverizer, and 92-98 wt % of bean milk separated in the separation process mixing with 2-8 wt % of ginger additives formed in the preparation process in the reaction vessel to make the nutritive bean milk.

### EXAMPLE 9

Example 5 applies to example 9 except for the process of preparing the onion additives in which the onions are washed, pulverized by millstone pulverizer; and after heating bean flour formed in the pulverization process at a temperature of 100° C. for 25 minutes in the reaction vessel, the said onion additives are mixed in the amount of 5-20 wt % of the bean flour to be heated at a temperature of 100° C. for 20 minutes; the processed goods are formed.

### EXAMPLE 10

Example 6 applies to example 10 except for the process of preparing the onion additives in which the onions are washed, pulverized by millstone pulverizer, and 75-95 wt % of bean milk separated in the separation process mixing with 5-25 wt % of onion additives formed in the preparation process in the reaction vessel to make the nutritive bean milk.

### EXAMPLE 11

Example 5 applies to example 11 except for the process of preparing the garlic additives in which the garlics are washed, pulverized by millstone pulverizer; and after heating bean flour formed in the pulverization process at a temperature of 100° C. for 20 minutes in the reaction vessel, the said garlic additives are mixed in the amount of 5-15 wt % of the bean flour to be heated at a temperature of 100° C. for 30 minutes; the processed goods are formed.

### EXAMPLE 12

Example 6 applies to example 12 except for the process of preparing the garlic additives in which the garlics are washed, pulverized by millstone pulverizer, and 85-97 wt % of bean milk separated in the separation process mixing with 3-15 wt % of garlic additives formed in the preparation process in the reaction vessel to make the nutritive bean milk.

### EXAMPLE 13

Beans are cleanly washed. Then put them into a water tank to be soaked for 24 hours. Soaked beans are pulverized by millstone pulverizer with water 2 times of the bean in amount to form a bean flour. Spinach are cleanly washed. Then the spinach are pulverized by millstone pulverizer to help the ingredients of them well soaked. Then they become spinach additives, Bean flour formed in the said pulverization process put in a reaction vessel and heat them at a temperature of 100° C. for 40 minutes and mix with spinach additives in the amount of 10-30 wt % of the bean flour and heat them at a temperature of 100° C. for 5 minutes to make the processed goods. The above said processed goods pass through a 200 mesh sieve to sift out bean curd refuge from bean milk. The said nutritive bean milk is heated at a temperature of 80-90° C. and add 0.04 wt % of coagulating agent to make a nutritive uncurdled bean curd. The nutritive uncurdled bean curd is put in a machine to compress and dehydrate to form a nutritive bean curd.

### EXAMPLE 14

Beans are cleanly washed. Then put them into a water tank to be soaked for 24 hours. Soaked beans are pulverized by millstone pulverizer with water 2 times of the bean in amount to form a bean flour. Spinach are cleanly washed. Then the spinach are pulverized by millstone pulverizer to prepare the spinach additives. Bean flour formed in the said pulverization process put in a reaction vessel and heat them at a temperature of 100° C. for 40 minutes to form a processed goods. The above said processed goods pass through a 200 mesh sieve to sift out bean curd refuge from bean milk. 75-90 wt % of the said bean milk is mixed with 10-25 wt % of spinach additives in the reaction vessel to form a nutritive bean milk; The said nutritive bean milk is heated at a temperature of 80-90° C. and add 0.04 wt % of coagulating agent to make a nutritive uncurdled bean curd. The nutritive uncurdled bean curd is put in a machine to compress and dehydrate to form a nutritive bean curd.

### EXAMPLE 15

Example 13 applies to example 15 except for the process of preparing the leek additives in which the leeks are washed, pulverized by millstone pulverizer; and after heating bean flour formed in the pulverization process at a temperature of 100° C. for 40 minutes in the reaction vessel, the said leek additives are mixed in the amount of 5-25 wt % of the bean flour to be heated at a temperature of 100° C. for 10 minutes; the processed goods are formed.

### EXAMPLE 16

Example 14 applies to example 16 except for the process of preparing the leek additives in which the leeks are washed, pulverized by millstone pulverizer, and 80-97 wt % of bean milk separated in the separation process mixing with 3-20 wt % of garlic additives formed in the preparation process in the reaction vessel to make the nutritive bean milk.

### EXAMPLE 17

Example 13 applies to example 17 except for the process of preparing the green onion additives in which the green onions are washed, pulverized by millstone pulverizer; and after heating bean flour formed in the pulverization process at a temperature of 100° C. for 40 minutes in the reaction vessel, the said leek additives are mixed in the amount of 3-15 wt % of the bean flour to be heated at a temperature of 100° C. for 10 minutes; the processed goods are formed.

### EXAMPLE 18

Example 14 applies to example 18 except for the process of preparing the green onion additives in which the green onions are washed, pulverized by millstone pulverizer, and 85-97 wt % of bean milk separated in the separation process mixing with 3-15 wt % of green onion additives formed in the preparation process in the reaction vessel to make the nutritive bean milk.

### EXAMPLE 19

Example 13 applies to example 19 except for the process of preparing the crown daisy additives in which the crown daisies are washed, pulverized by millstone pulverizer; and after heating bean flour formed in the pulverization process at a temperature of 100° C. for 40 minutes in the reaction vessel, the said crown daisy additives are mixed in the amount of 10-30 wt % of the bean flour to be heated at a temperature of 100° C. for 13 minutes; the processed goods are formed.

### EXAMPLE 20

Example 14 applies to example 20 except for the process of preparing the crown daisy additives in which the crown daisies are washed, pulverized by millstone pulverizer, and 80-95 wt % of bean milk separated in the separation process mixing with 5-20 wt % of crown daisy additives formed in the preparation process in the reaction vessel to make the nutritive bean milk.

### EXAMPLE 21

Example 13 applies to example 21 except for the process of preparing the carrot additives in which the carrots are washed, pulverized by millstone pulverizer; and after heating bean flour formed in the pulverization process at a temperature of 100° C. for 40 minutes in the reaction vessel, the said carrot additives are mixed in the amount of 15-40 wt % of the bean flour to be heated at a temperature of 100° C. for 5 minutes; the processed goods are formed.

### EXAMPLE 22

Example 14 applies to example 22 except for the process of preparing the carrot additives in which the carrots are washed, pulverized by millstone pulverizer, and 70-90 wt % of bean milk separated in the separation process mixing with 10-30 wt % of carrot additives formed in the preparation process in the reaction vessel to make the nutritive bean milk.

### EXAMPLE 23

Example 13 applies to example 23 except for the process of preparing the sesame leaves additives in which the sesame leaves are washed, pulverized by millstone pulverizer; and after heating bean flour formed in the pulverization process at a temperature of 100° C. for 40 minutes in the reaction vessel, the said sesame leaves additives are mixed in the amount of 15-35 wt % of the bean flour to be heated at a temperature of 100° C. for 10 minutes; the processed goods are formed.

### EXAMPLE 24

Example 14 applies to example 24 except for the process of preparing the sesame leaves additives in which the sesame leaves are washed, pulverized by millstone pulverizer, and 80-95 wt % of bean milk separated in the separation process mixing with 5-20 wt % of sesame leaves additives formed in the preparation process in the reaction vessel to make the nutritive bean milk.

### EXAMPLE 25

Example 13 applies to example 25 except for the process of preparing the worm wood additives in which the worm woods are washed, pulverized by millstone pulverizer; and after heating bean flour formed in the pulverization process at a temperature of 100° C. for 40 minutes in the reaction vessel, the said worm wood additives are mixed in the amount of 10-35 wt % of the bean flour to be heated at a temperature of 100° C. for 10 minutes; the processed goods are formed.

### EXAMPLE 26

Example 14 applies to example 26 except for the process of preparing the worm wood additives in which the worm woods are washed, pulverized by millstone pulverizer, and 70-95 wt % of bean milk separated in the separation process mixing with 10-30 wt % of worm woods additives formed in the preparation process in the reaction vessel to make the nutritive bean milk.

### EXAMPLE 27

Example 13 applies to example 27 except for the process of preparing the pine leaves additives in which the pine leaves are washed, pulverized by millstone pulverizer; and after heating bean flour formed in the pulverization process at a temperature of 100° C. for 40 minutes in the reaction vessel, the said pine leaves additives are mixed in the amount of 5-35 wt % of the bean flour to be heated at a temperature of 100° C. for 10 minutes; the processed goods are formed.

### EXAMPLE 28

Example 14 applies to example 28 except for the process of preparing the pine leaves additives in which the pine leaves are washed, pulverized by millstone pulverizer, and 80-95 wt % of bean milk separated in the separation process mixing with 5-20 wt % of pine leaves additives formed in the preparation process in the reaction vessel to make the nutritive bean milk.

### EXAMPLE 29

Example 13 applies to example 29 except for the process of preparing the green tea additives in which the green teas are washed, pulverized by millstone pulverizer; and after heating bean flour formed in the pulverization process at a temperature of 100° C. for 40 minutes in the reaction vessel, the said green tea additives are mixed in the amount of 5-15 wt % of the bean flour to be heated at a temperature of 100° C. for 3 minutes; the processed goods are formed.

### EXAMPLE 30

Example 14 applies to example 30 except for the process of preparing the green tea additives in which the green teas are washed, pulverized by millstone pulverizer, and 85-97 wt % of bean milk separated in the separation process mixing with 3-15 wt % of green tea additives formed in the preparation process in the reaction vessel to make the nutritive bean milk.

The aforesaid examples explained about making nutritive bean curd mixing bean flour with a kind of vegetable additives. However, the nutritive bean curd can also be made by mixing bean flour with more than one kind of vegetable additives.

Effect of Invention

The present invention relates to manufacturing method of nutritive bean curd by mixing a bean flour and vegetable additives containing an allyl sulfide, flavonoid, saponin and hydrated acid and many other ingredients which have good and fragrant tastes and have a lot of vitamins and minerals. The present bean curd contains all sorts of nutrition and effective ingredients of said vegetable food and eliminates a somewhat fishy smell of bean's peculiar flavor and applies this tasty bean curd in cooking various food. Nutritive bean curd produced by the said method is tinged with the same color of the vegetable additives and is superior than the normal bean curd in taste and quality.

What is claimed is:

1. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing ginseng;
forming a processed materials heating 85-97 wt % of bean flour formed in the said pulverization process and 3-15 wt % of the ginseng additives in the said preparation process are mixed in a reaction vessel and heat them at a temperature of 100° C. for 70 minutes to make the ingredients of ginseng additives are sufficiently soaked and at last the processed goods come to be;
separating a bean milk and bean curd refuge by filtering the processed goods produced by the heating procedure by passing through a 200 mesh sieve to sift out bean curd refuge from bean milk;
heating the separated bean milk in a reaction vessel in a temperature of 80˜90° C. and coagulating the bean milk adding coagulation agent 0.02 wt % of bean milk to make a nutritive uncurdled bean curd; and
forming nutritive bean curd condensing and dehydrating the said nutritive uncurdled bean curd;

2. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing mulberry leaves;
forming a processed materials mixing 75-90 wt % of bean flour formed in the said pulverization process and 10-25 wt % of the mulberry leaves additives in the said preparation process in a reaction vessel and heating them at a temperature of 100° C. for 60 minutes to make the ingredients of mulberry leaves additives are sufficiently soaked and at last the processed goods come to be;
separating a bean milk and bean curd refuge by filtering the processed goods produced by the heating procedure by passing through a 200 mesh sieve to sift out bean curd refuge from bean milk;
heating the separated bean milk in a reaction vessel in a temperature of 80˜90° C. and coagulating the bean milk adding coagulation agent 0.02 wt % of bean milk to make a nutritive uncurdled bean curd; and
forming nutritive bean curd condensing and dehydrating the said nutritive uncurdled bean curd;

3. Method of manufacturing for nutritive bean curd comprising steps of:
washing a bean and soak the bean in water for 24 hours;
making a bean flour pulverizing the soaked bean after mixing water which amount is 2 times the soaked bean preparing a vegetable additives by washing and pulverizing pumpkin;
forming a processed materials after heating the bean flour formed in the said pulverization process at a temperature of 100° C. for 30 minutes and mixing thereto the said pumpkin additives in the said preparation process the amount of which is 15-35 wt % of the bean flour and heat the mixture at a temperature of 100° C. for 20 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.03 wt % of bean milk to make a nutritive uncurdled bean curd; and
forming nutritive bean curd condensing and dehydrating the said nutritive uncurdled bean curd;

4. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing ginger;
forming a processed materials after heating the bean flour formed in the said pulverization process at a temperature of 100° C. for 20 minutes and mixing thereto the said ginger additives in the said preparation process the amount of which is 3 -10 wt % of the bean flour and heat the mixture at a temperature of 100° C. for 25 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.03 wt % of bean milk to make a nutritive uncurdled bean curd; and
a process of forming nutritive bean curd condensing and dehydrating the said nutritive uncurdled bean curd;

5. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing onion;
forming a processed materials after heating the bean flour formed in the said pulverization process at a temperature of 100° C. for 25 minutes and mixing thereto the said onion additives in the said preparation process the amount of which is 5-20 wt % of the bean flour and heat the mixture at a temperature of 100° C. for 20 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.03 wt % of bean milk to make a nutritive uncurdled bean curd; and
forming nutritive bean curd condensing and dehydrating the said nutritive uncurdled bean curd;

6. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing garlic;
forming a processed materials after heating the bean flour formed in the said pulverization process at a temperature of 100° C. for 20 minutes and mixing thereto the said garlic additives in the said preparation process the amount of which is 5-15 wt % of the bean flour and heat the mixture at a temperature of 100° C. for 30 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.03 wt % of bean milk to make a nutritive uncurdled bean curd; and
forming nutritive bean curd condensing and dehydrating the said nutritive uncurdled bean curd;

7. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing spinach;
forming a processed materials after heating the bean flour formed in the said pulverization process at a temperature of 100° C. for 40 minutes and mixing thereto the said spinach additives in the said preparation process the amount of which is 10-30 wt % of the bean flour and heat the mixture at a temperature of 100° C. for 5 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

8. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing leek;
forming a processed materials after heating the bean flour formed in the said pulverization process at a temperature of 100° C. for 40 minutes and mixing thereto the said leek additives in the said preparation process the amount of which is 5-25 wt % of the bean flour and heat the mixture at a temperature of 100° C. for 10 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

9. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing green onion;
forming a processed materials after heating the bean flour formed in the said pulverization process at a temperature of 100° C. for 40 minutes and mixing thereto the said green onion additives in the said preparation process the amount of which is 3-15 wt % of the bean flour and heat the mixture at a temperature of 100° C. for 10 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

10. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing crown daisy;
forming a processed materials after heating the bean flour formed in the said pulverization process at a temperature of 100° C. for 40 minutes and mixing thereto the said crown daisy additives in the said preparation process the amount of which is 10-30 wt % of the bean flour and heat the mixture at a temperature of 100° C. for 7 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

11. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing carrot;
forming a processed materials after heating the bean flour formed in the said pulverization process at a temperature of 100° C. for 40 minutes and mixing thereto the said carrot additives in the said preparation process the amount of which is 15-40 wt % of the bean flour and heat the mixture at a temperature of 100° C. for 5 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

12. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing sesame leaves;
forming a processed materials after heating the bean flour formed in the said pulverization process at a temperature of 100° C. for 40 minutes and mixing thereto the said sesame leaves additives in the said preparation process the amount of which is 15-35 wt % of the bean flour and heat the mixture at a temperature of 100° C. for 10 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

13. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing wormwood;
forming a processed materials after heating the bean flour formed in the said pulverization process at a temperature of 100° C. for 40 minutes and mixing thereto the said wormwood additives in the said preparation process the amount of which is 10-35 wt % of the bean flour and heat the mixture at a temperature of 100° C. for 10 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

14. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing pine leaves;
forming a processed materials after heating the bean flour formed in the said pulverization process at a temperature of 100° C. for 40 minutes and mixing thereto the said pine leaves additives in the said preparation process the amount of which is 5-30 wt % of the bean flour and heat the mixture at a temperature of 100° C. for 10 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;

15. Method of manufacturing for nutritive bean curd comprising steps of:
washing a bean and soak the bean in water for 24 hours;
making a bean flour pulverizing the soaked bean after mixing water which amount is 2 times the soaked bean;
preparing a vegetable additives by washing and pulverizing green tea;
forming a processed materials after heating the bean flour formed in the said pulverization process at a temperature of 100° C. for 40 minutes and mixing thereto the said green tea additives in the said preparation process the amount of which is 3-15 wt % of the bean flour and heat the mixture at a temperature of 100° C. for 3 minutes.
separating a bean milk and bean curd refuge by filtering the processed goods produced by the heating process by passing through a 200 mesh sieve to sift out bean curd refuge from bean milk;
heating the separated bean milk in a reaction vessel in a temperature of 80˜90° C. and coagulating the bean milk adding coagulation agent 0.04 wt % of bean milk to make a nutritive uncurdled bean curd; and
forming nutritive bean curd condensing and dehydrating the said nutritive uncurdled bean curd;
